(19) United States
(12) Patent Application Publication
(10) Pub. No.: US 2019/0271139 A1
(43) Pub. Date: Sep. 5, 2019

(54) CONNECTING APPARATUS FOR FAUCET HANDLE

(71) Applicant: Ta-Yu Yeh, Changhua (TW)

(72) Inventor: Ta-Yu Yeh, Changhua (TW)

(73) Assignee: ALEXANDER YEH INDUSTRY CO., LTD., CHANGHUA (TW)

(21) Appl. No.: 15/910,402

(22) Filed: Mar. 2, 2018

(51) Int. Cl. E03C 1/04; F16B 21/09

(52) U.S. Cl. CPC E03C 1/0412; F16B 21/09

(57) ABSTRACT

A connecting apparatus for faucet handle may comprise a connecting unit which is configured to be applied to and enable a first handle or a second handle to be installed on a faucet. The connecting unit has a connecting base, two engaging blocks and two connecting members, and the two connecting members can be screwed in or out to enable the engaging blocks to be moved toward or away from each other, which allows the connecting unit to be applied to different sizes and shapes of a control shaft of the faucet.

### FIELD OF THE INVENTION

The present invention relates to a connecting apparatus and more particularly to a connecting apparatus that enables different faucet handles to be applied to a faucet.

### BACKGROUND OF THE INVENTION

With the improvement of living standard, consumers have higher pursuits in the outlook of a faucet, and sometimes they will try to change a faucet handle of a faucet by themselves. However, various faucets in the market comprise different control shafts having different dimensions and cross-section shapes, which results that consumers need to spend time to look for a handle having corresponding size and shape or waste time in assembly process. Therefore, there remains a need for a new and improved design for a connecting apparatus for faucet handle to overcome the problems presented above.

### SUMMARY OF THE INVENTION

The present invention provides a connecting apparatus for faucet handle which comprises a connecting unit which is configured to be applied to and enable a first handle or a second handle to be installed on a faucet. The connecting unit has a connecting base, two engaging blocks and two connecting members. Moreover, the connecting base comprises an install hole axially penetrating through a central portion thereof, and two screw holes respectively penetrate through a front side and a rear side of the connecting base to communicate with the install hole. Two driving legs protrude from a top surface of the connecting base respectively adjacent to two lateral sides of the install hole, and each of two lateral sides of the connecting base has a cutting edge which is configured to extend to and shape the same side of the driving leg in a half-cylinder shape. Each of the engaging blocks has a first edge, a second edge and a connecting hole, wherein the second edge comprises a stepped surface and the connecting hole is configured to penetrate through the first edge and the second edge. The two engage blocks are positioned into the install hole to enable the two second edges to be arranged face to face, and each of the two connecting members is configured to penetrate through the screw hole and the connecting hole on the same side to secure the engaging block inside the install hole. Through screwing the connecting members clockwise or counterclockwise, the two connecting members are configured to drive the two engaging blocks to move toward each other or to move away from each other. The first handle has a shell, and a first lever is installed on a top end thereof. A first upper housing formed inside the first handle at an upper portion thereof comprises two first driving holes. The second handle has a cover and a second lever which are configured to be engaged and secured together through a screw or a fastener. An upper portion of the cover comprises a neck portion which has a diameter gradually smaller from bottom to top, and a second upper housing is formed inside the neck portion. The second upper housing has two second driving holes therein, and the second upper housing is smaller than the first upper housing of the first handle.

The present invention is advantageous because: (i) the connecting unit enables at least two different handles to be installed on the faucet; and (ii) the two connecting members can be screwed in or out to enable the engaging blocks to be moved toward or away from each other, which allows the connecting unit to be applied to different sizes and shapes of the control shaft of the faucet. Thus, a consumer does not need to waste time to find corresponding faucet handle, thereby saving time and effort.

### BRIEF DESCRIPTION OF THE DRAWINGS

FIG. 1 is a three-dimensional exploded view illustrating a connecting apparatus for faucet handle of the present invention is applied to a first handle or a second handle.

FIG. 2 is a three-dimensional enlarged view of the connecting apparatus of the present invention.

FIG. 3 is a sectional view of the connecting apparatus of the present invention.

FIG. 4 is a schematic view illustrating two connecting members of the connecting apparatus respectively drive two engaging blocks to have movements in the present invention.

FIG. 5 is a schematic view illustrating the first handle is installed on a faucet through the connecting apparatus of the present invention.

FIG. 6 is a sectional view illustrating the first handle is installed on the faucet through the connecting apparatus of the present invention.

FIG. 7 is a sectional assembly view illustrating the first handle is engaged with the connecting apparatus of the present invention.

FIG. 8 is a schematic view illustrating the second handle is installed on the faucet through the connecting apparatus of the present invention.

FIG. 9 is a sectional view illustrating the second handle is installed on the faucet through the connecting apparatus of the present invention.

FIG. 10 is a sectional assembly view illustrating the second handle is engaged with the connecting apparatus of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

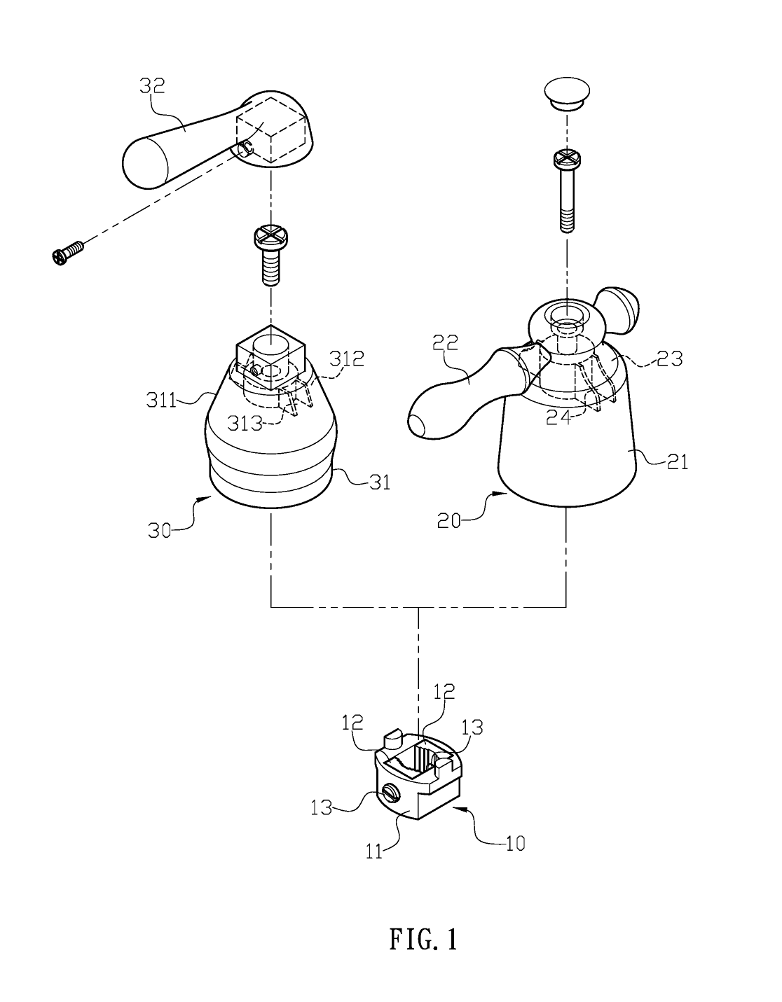

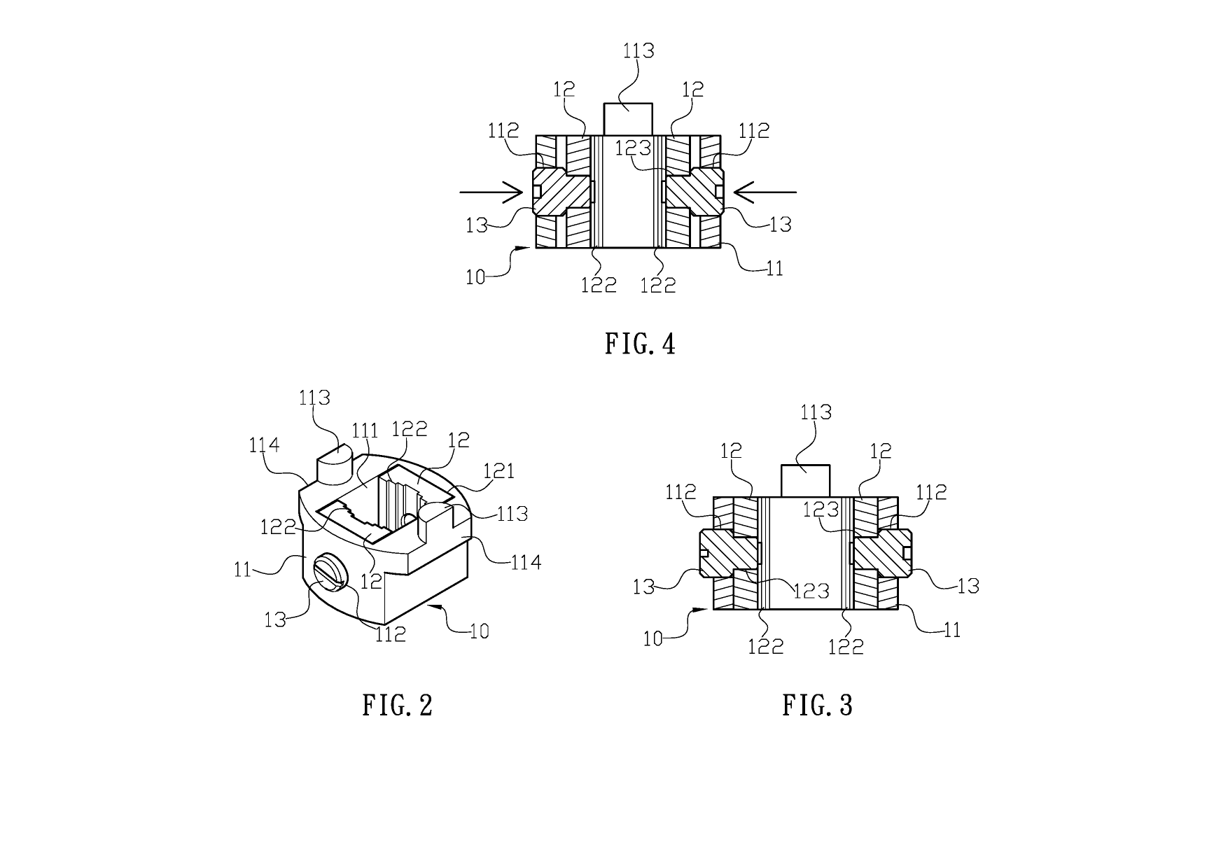

Referring to FIGS. 1 to 3, the present invention provides a connecting apparatus for faucet handle which comprises a connecting unit (10) which is configured to be applied to and enable a first handle (20) or a second handle (30) to be installed on a faucet (40). The connecting unit (10) has a connecting base (11), two engaging blocks (12) and two connecting members (13). Moreover, the connecting base (11) comprises an install hole (111) axially penetrating through a central portion thereof, and two screw holes (112) respectively penetrate through a front side and a rear side of the connecting base (11) to communicate with the install hole (111). Two driving legs (113) protrude from a top surface of the connecting base (11) respectively adjacent to two lateral sides of the install hole (111), and each of two lateral sides of the connecting base (11) has a cutting edge (114) which is configured to extend to and shape the same side of the driving leg (113) in a half-cylinder shape. Each of the engaging blocks (12) has a first edge (121), a second edge (122) and a connecting hole (123), wherein the second edge (122) comprises a stepped surface and the connecting hole (123) is configured to penetrate through the first edge (121) and the second edge (122). The two engage blocks (12) are positioned into the install hole (111) to enable the two second edges (122) to be arranged face to face, and each of the two connecting members (13) is configured to penetrate through the screw hole (112) and the connecting hole (123) on the same side to secure the engaging block (12) inside the install hole (111). Through screwing the connecting members (13) clockwise or counterclockwise, the two connecting members (13) are configured to drive the two engaging blocks (12) to move toward each other (as shown in FIG. 4) or to move away from each other. The first handle (20) has a shell (21), and a first lever (22) is installed on a top end thereof. A first upper housing (23) formed inside the first handle (20) at an upper portion thereof comprises two first driving holes (24). The second handle (30) has a cover (31) and a second lever (32) which are configured to be engaged and secured together through a screw or a fastener. An upper portion of the cover (31) comprises a neck portion (311) which has a diameter gradually smaller from bottom to top, and a second upper housing (312) is formed inside the neck portion (311). The second upper housing (312) has two second driving holes (313) therein, and the second upper housing (312) is smaller than the first upper housing (23) of the first handle (20).

In one embodiment, the connecting member (13) is a stepped rod, and a largest-diameter section of the connecting member (13) has an outer threaded section which is configured to enable the connecting member (13) to engage with the screw hole (112) of the connecting base (11).

In another embodiment, the faucet (40) is a single-handle faucet.

In still another embodiment, the faucet (40) is a double-handle faucet.

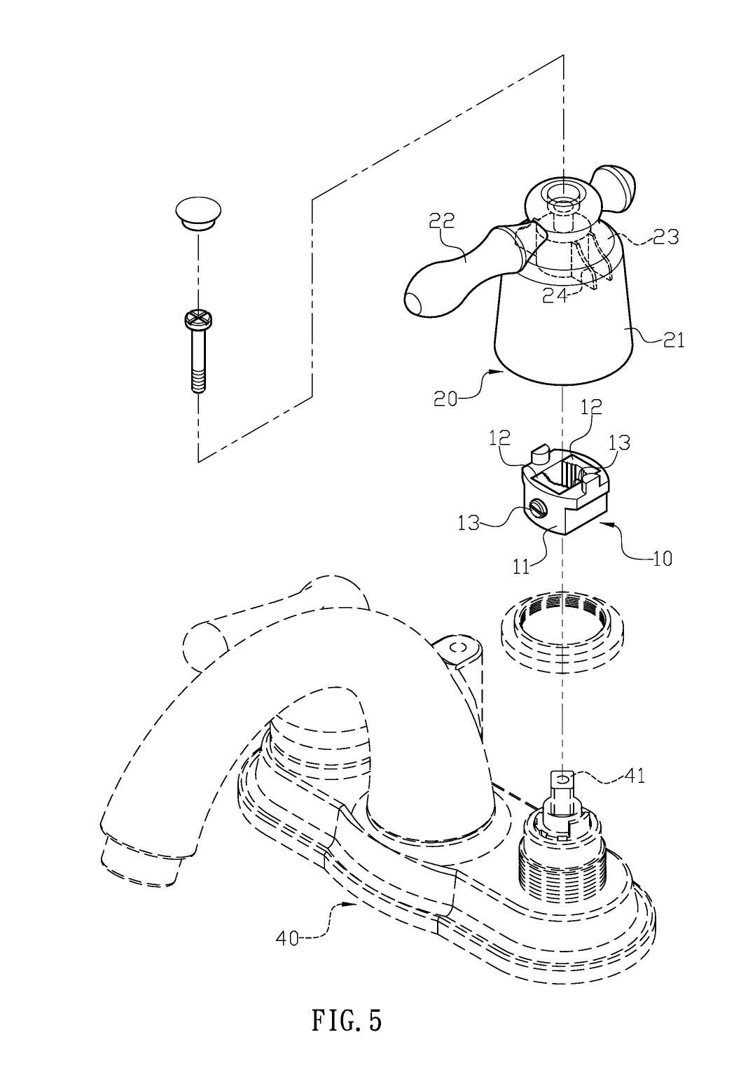

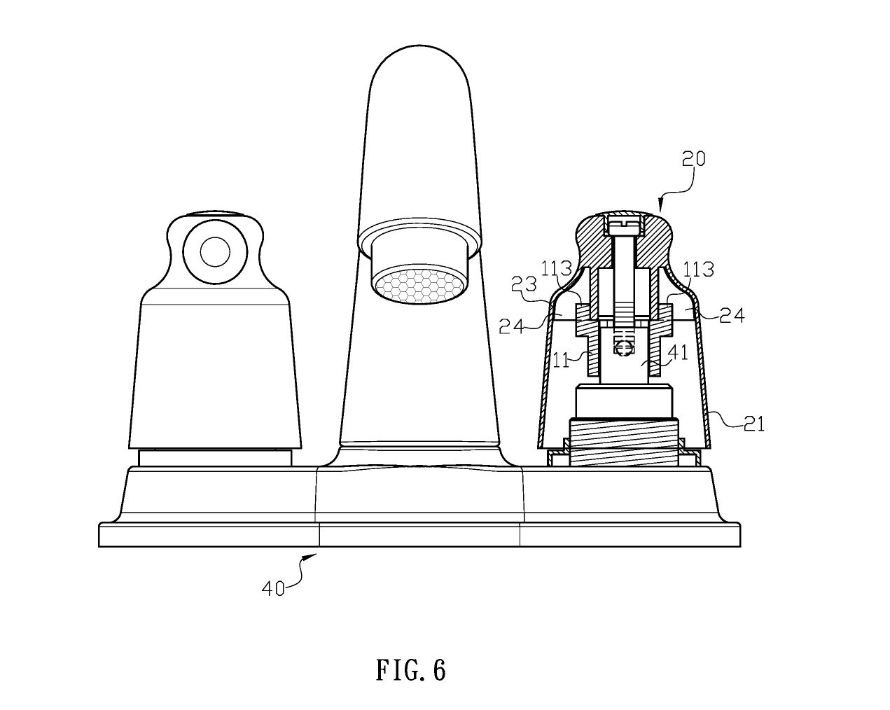

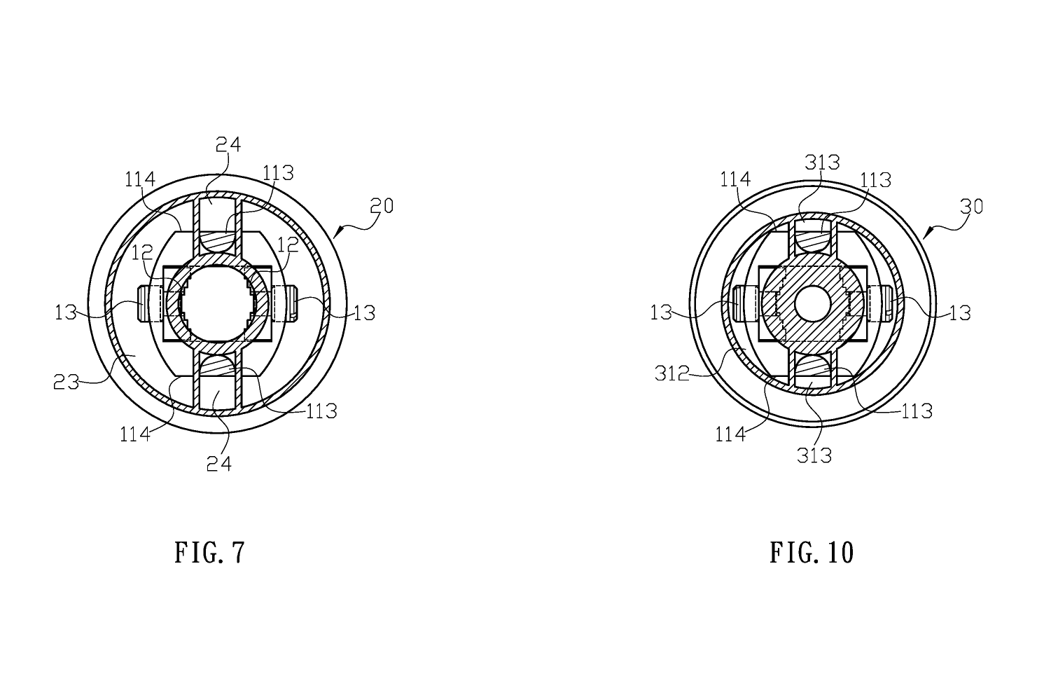

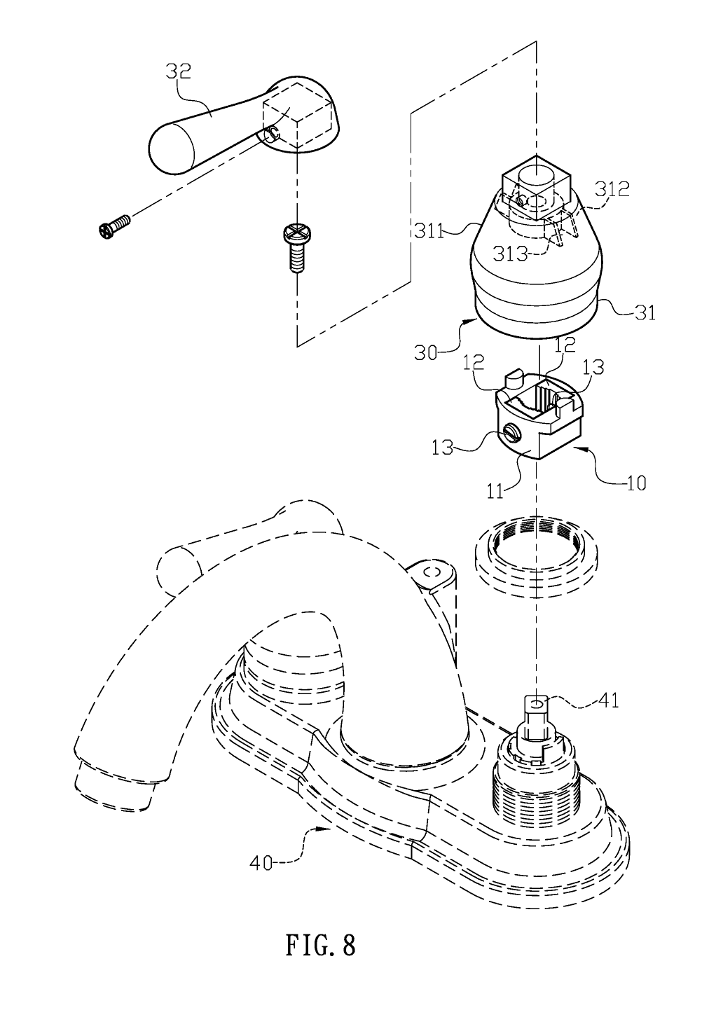

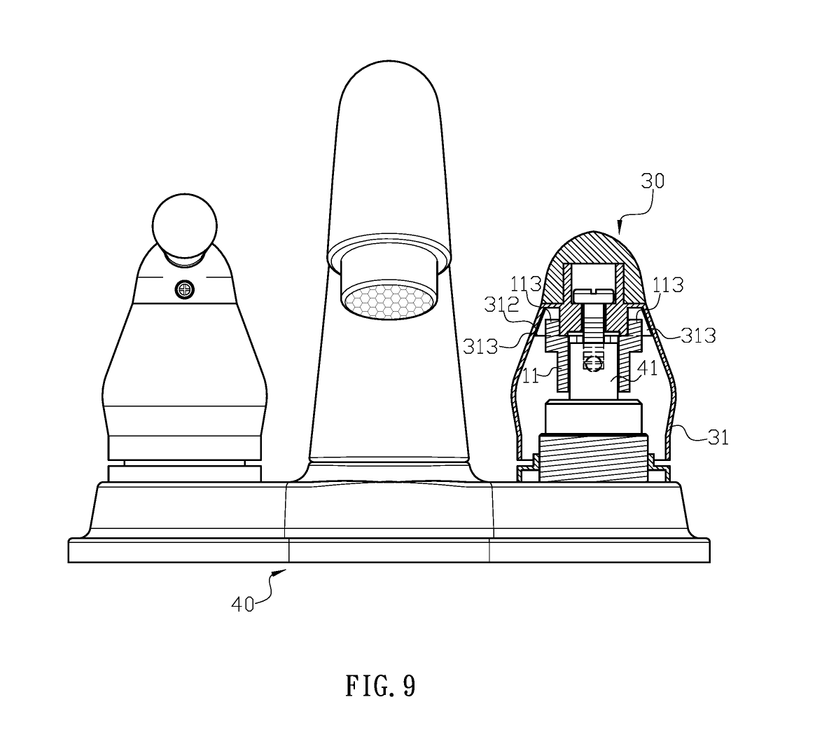

In actual application, the two engaging blocks (12) are locked to enable the connecting unit (10) to be secured on a control shaft (41) of the faucet (40). The shell (21) of the first handle (20) is configured to cover the connecting unit (10), and the connecting unit (10) is adapted to protrude into the first upper housing (23) of the first handle (20). Meanwhile, the driving legs (113) are respectively engaged with the first driving holes (24), and the first handle (20) is secured on the control shaft (41). Thus, through the connecting unit (10), the first handle (20) is configured to be driven by the control shaft (41) (as shown in FIGS. 5 to 7). On the other hand, with the cutting edges (114), the connecting base (11) can also be applied to the second handle (30) which has the second upper housing (312) smaller than the first upper housing (23). Similarly, the driving legs (113) are configured to respectively engage with the second driving holes (313), and the second handle (30) is adapted to be engaged with and driven by the control shaft (41) (as shown in FIGS. 8 to 10). Furthermore, the two connecting members (13) are configured to be screwed in or out to enable the two engaging blocks (12) to be moved toward or away from each other, and with the second edges (122) having the stepped surface, the connecting unit (10) can be applied to different sizes and shapes of the control shaft (41) of the faucet (40).

The present invention is advantageous because: (i) the connecting unit (10) enables at least two different handles to be installed on the faucet (40); and (ii) the two connecting members (13) can be screwed in or out to enable the engaging blocks (12) to be moved toward or away from each other, which allows the connecting unit (10) to be applied to different sizes and shapes of the control shaft (41) of the faucet (40). Thus, a consumer does not need to waste time to find corresponding faucet handle, thereby saving time and effort.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A connecting apparatus for faucet handle having a connecting unit configured to be applied to and enable a first handle or a second handle to be installed on a faucet; the connecting unit comprising a connecting base, two engaging blocks and two connecting members;
wherein the connecting base comprises an install hole axially penetrating through a central portion thereof, and two screw holes respectively penetrate through a front side and a rear side of the connecting base to communicate with the install hole; two driving legs protrude from a top surface of the connecting base respectively adjacent to two lateral sides of the install hole, and each of two lateral sides of the connecting base has a cutting edge; and
wherein each of the engaging blocks has a first edge, a second edge and a connecting hole; the second edge comprises a stepped surface and the connecting hole is configured to penetrate through the first edge and the second edge; the two engage blocks are positioned into the install hole to enable the two second edges to be arranged face to face, and each of the two connecting members is configured to pass through the screw hole and the connecting hole on the same side to secure the engaging block inside the install hole; through screwing the connecting members clockwise or counterclockwise, the two connecting members are configured to respectively drive the two engaging blocks to move toward or away from each other.

2. The connecting apparatus for faucet handle of claim 1, wherein each of the cutting edges is configured to extend to and shape the same side of the driving leg in a half-cylinder shape.

3. The connecting apparatus for faucet handle of claim 1, wherein the connecting member is a stepped rod, and a largest-diameter section of the connecting member has an outer threaded section.

4. The connecting apparatus for faucet handle of claim 1, wherein the first handle has a shell, and a first lever is installed on a top end thereof; a first upper housing formed inside the first handle at an upper portion thereof comprises two first driving holes; the second handle has a cover and a second lever which are configured to be engaged and secured together through a screw or a fastener; an upper portion of the cover comprises a neck portion which has a diameter gradually smaller from bottom to top, and a second upper housing is formed inside the neck portion; the second upper housing has two second driving holes therein, and the second upper housing is smaller than the first upper housing of the first handle.
